(19) United States
(12) Patent Application Publication
(10) Pub. No.: US 2005/0093683 A1
(43) Pub. Date: May 5, 2005

(54) Method and system for alarming against theft and/or towing of a vehicle that utilizes a TPMS (tire pressure monitoring system)

(76) Inventors: Sung Don Wee, Seongnam-city (KR); Seong Tae Kim, Wonju-city (KR)

Correspondence Address: MORGAN, LEWIS & BOCKIUS LLP (SF), 2 PALO ALTO SQUARE, PALO ALTO, CA, 94306, US

(21) Appl. No.: 10/975,131

(22) Filed: Oct. 27, 2004

(30) Foreign Application Priority Data
Nov. 1, 2003 (KR) 10-2003-0077145

(51) Int. Cl. B60R 25/10

(52) U.S. Cl. 340/426.1; 340/442

(57) ABSTRACT

A method and system for alarming against theft and/or towing of a vehicle that utilizes a TPMS (Tire Pressure Monitoring System) for detecting internal air pressures of tires in a real time and a vehicle theft. In addition, the theft and/or towing alarms are determined by detecting change (drop) of the air pressures of the tires and the alarm system is turned on by a determination thereof, and simultaneously informed the determination through a wireless terminal of an owner or a manager of the vehicle. Therefore, with preventing of the vehicle theft by an operation of the alarm system, the present invention is for dealing with the vehicle theft and towing by the owner or the manager of the vehicle positively and for improving a confidence to the vehicle.

### CROSS-REFERENCE TO RELATED APPLICATIONS

This application claims priority of Korean Application No. 10-2003-0077145, filed Nov. 1, 2003, the disclosure of which is incorporated herein by reference.

### FIELD OF THE INVENTION

Generally, the present invention relates to a method and system for alarming against theft and/or towing of a vehicle. More particularly, the present invention relates to the method and system for alarming against theft and/or towing of a vehicle that utilizes a TPMS (Tire Pressure Monitoring System) for detecting an internal air pressure of a tire in real time.

### BACKGROUND OF THE INVENTION

Generally, an anti-theft device mounted in a vehicle detects a force through a sensor and sounds an alarm or turns on a light mounted on the vehicle in the case that a physical force acts on the vehicle. However, such an anti-theft device cannot transmit an alarm of theft and/or towing of a vehicle in the case that an owner or a manager of the vehicle is remote.

In such instances, dealing with the theft and/or towing alarm of the vehicle becomes delayed, and the anti-theft device, such as a separate sensor, must be mounted and operated. In addition, a problem occurs in which damage is caused by a noise by an error of the anti-theft device.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

Embodiments of the present invention provide a method and system for alarming against theft and/or towing of a vehicle that utilizes a TPMS (Tire Pressure Monitoring System). An exemplary embodiment of the present invention includes an input device, a control device, an alarm device, and a terminal.

In a further embodiment, the method and system for alarming against theft and/or towing of a vehicle that utilizes a TPMS (Tire Pressure Monitoring System) detects internal air pressures of tires in a real time and determines a vehicle theft and towing by a change (drop) of the detected air pressures of the tires.

In another further embodiment, the present invention is for providing the method and system for alarming against theft and/or towing of the vehicle that utilizes a TPMS (Tire Pressure Monitoring System) which operates the alarm device and simultaneously informs an alarm to a wireless terminal of an owner or a manager of the vehicle.

In another further embodiment, the method for alarming against theft and/or towing of the vehicle comprises detecting internal pressures of the tires mounted in the vehicle, comparing the detected pressures with a predetermined pressure value, operating a timer if at least one of differences between the detected pressures and the predetermined pressure value is within a scope of a predetermined allowable error and generating an alarm message in the case that a state that at least one of the differences between the detected pressures and the predetermined pressure value is within the scope of the predetermined allowable error and is maintained for a predetermined period.

The predetermined pressure value is a pressure of the tires when a load of the vehicle does not act on the tires. Detecting the internal pressures of the tires may be performed by a TPMS (Tire Pressure Monitoring System).

A system for alarming against theft and/or towing of a vehicle comprises an input device for detecting pressures of tires and for outputting a pressure signal corresponding to the detected pressures, a control device for receiving the pressure signal from the input device, and for outputting a control signal for alarming against theft and/or towing of the vehicle based on a comparison between the pressure value according to the signal and the predetermined pressure value, an alarm device operated by the control signal from the control device, and a terminal for receiving an alarm message according to the control signal of the control device.

The predetermined pressure value is a pressure of the tires when a load of the vehicle does not act on the tires and wherein the control device outputs the control signal for alarming of theft and/or towing of the vehicle in the case that a state that at least one of the differences between the detected pressures and the predetermined pressure value is in a scope of a predetermined allowable error during the predetermined period.

A control device comprises a receiving portion receiving the pressure signal from the input device and converting the pressure signal into processable data, a storing portion for storing the predetermined pressure value, the scope of the predetermined allowable error, and the predetermined period, a processing portion for comparing the pressure signal with the data stored in the storing portion and for transmitting a result thereof, a control portion for transmitting a control signal according to the result transmitted from the processing portion, a switch portion for operating the alarm device by the control signal transmitted from the control portion, and a transmitting portion for transmitting an alarm message to a terminal according to the control signal transmitted from the control portion.

The control device further comprises the timer operated by the result made by the processing portion.

A system for alarming against theft and/or towing of a vehicle comprises an input device for detecting pressures of tires and for outputting a pressure signal corresponding to the detected pressures, a control device for receiving the pressure signal from the input device, and for outputting a control signal for alarming against theft and/or towing of the vehicle based on a comparison between pressure values of the pressure signal and a predetermined pressure value, and an alarm device operated by the control signal from the control device.

The control device is configured to transmit a signal for alarming against theft and/or towing of the vehicle to a mobile communication terminal.

The predetermined pressure value is a pressure of the tires when a load of the vehicle does not act on the tires and the control device outputs the control signal for alarming against theft and/or towing of the vehicle in the case that the differences between the detected pressures and the predetermined pressure value is in a scope of a predetermined allowable error and is maintained for a predetermined period.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a flowchart of a method for alarming against theft and/or towing of a vehicle that utilizes a TPMS (Tire Pressure Monitoring System) according to an embodiment of the present invention; and

FIG. 2 is a block diagram of a system for a method and system for alarming against theft and/or towing of a vehicle that utilizes TPMS (Tire Pressure Monitoring System) according to an embodiment of the present invention.

### DETAILED DESCRIPTION OF THE PREFERRED EMBODIMENTS

An embodiment of the present invention will hereinafter be described in detail with reference to the accompanying drawings.

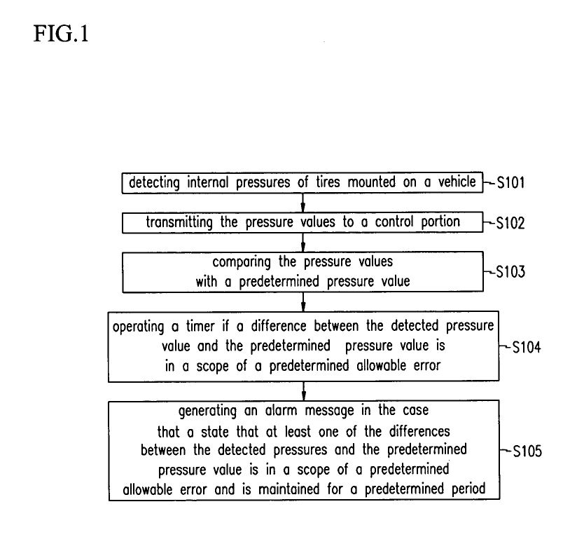

As shown in FIG. 1, internal pressures of tires are detected by the TPMS (Tire Pressure Monitoring System) mounted in the vehicle (S101).

In this case, the TPMS is a system for preventing an accident by alarming a driver of the vehicle in the case that detected pressures of the tires become lower than a predetermined pressure. The TPMS includes four sensors that are respectively mounted in the four tires of the vehicle.

In addition, the values of the pressure of the tires detected by the sensors are transmitted to an ECU (Electronic Control Unit) through wireless communication at regular intervals. In the case that the detected values of the pressure of the tires become lower than a predetermined pressure value, the ECU informs a driver of this.

Therefore, the pressure of the tires is detected by the TPMS mounted in the vehicle, and the pressure values of the tires are transmitted to a control portion (S102). The control portion compares the transmitted value with a predetermined pressure value (S103).

The predetermined pressure value is a pressure of the tires when a load of the vehicle does not act on the tires. That is, the predetermined pressure value is a value of the tire pressure when the vehicle is lifted up by a tow truck or the like.

In this case, the control portion is for processing data, and is preferably a portion of the ECU. The control portion can be realized by a specific circuit or a program running on an appropriate processor, either of which may be determined by a person skilled in the art based on the teachings herein.

When a front portion or a rear portion of the vehicle is lifted by a tow truck or the like, a load of the vehicle is taken from front or rear tires. Therefore, the pressures of the tires from which a load of the vehicle is taken become similar to the predetermined pressure value.

That is, if the pressures of the front left and right tires or the pressures of the rear left and right tires are changed to the predetermined pressure, the control portion determines that the vehicle is stolen or towed by a tow truck.

In this case, the pressure of the tire when no load of the vehicle acts on the tires is changed in response to a temperature of air inside the tires. Therefore, it is preferable that a scope of an allowable error of the predetermined pressure according to a change of the temperature is considered. That is, if at least one of differences between the detected pressures of the tires and the predetermined pressure is within the scope of the allowable error of the predetermined pressure, it is preferably determined that the vehicle is stolen or towed by the tow truck.

As an example, the scope of the allowable error of the predetermined pressure value is preferably about 25% of the predetermined pressure value, but another scope of the allowable error can be applied.

Therefore, in the case that at least one of the differences between the detected pressures of the tires and the predetermined pressure is within the scope of the allowable error, the control portion determines that the vehicle is stolen or towed by a tow truck, and operates a timer (S104). If it is determined using the timer that a state that at least one of the differences between the detected pressures and the predetermined pressure value is in the scope of the predetermined allowable error and is maintained for a predetermined period, the control portion generates and transmits a theft alarm (S105).

The predetermined time is preferably determined to be 30 seconds, but it is easily notable that it can be varied to other values.

Preferably, the theft alarm message is transmitted to a mobile communication terminal that an owner or a manager of the vehicle carries, and the theft alarm message can also be transmitted to an alarm device mounted in the vehicle.

The mobile communication terminal can be realized as a portable terminal or a PDA (Personal Digital Assistant) using a predetermined communication network.

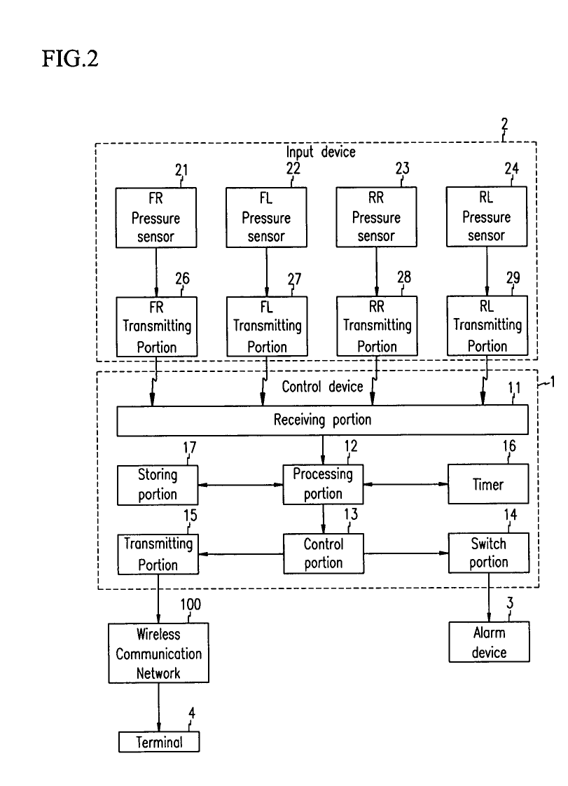

FIG. 2 is a block diagram for the system for alarming against theft and/or towing of the vehicle that utilizes the TPMS (Tire Pressure Monitoring System) according to an embodiment of the present invention.

An input device 2 detecting the pressures of the tires and transmitting a pressure signal corresponding to the detected pressure includes pressure sensors 21, 22, 23, and 24, and transmitting portions 26, 27, 28, and 29.

An FR pressure sensor 21 detects an air pressure of a front right tire of the vehicle, an FL pressure sensor 22 detects the air pressure of a front left tire of the vehicle, an RR pressure sensor 23 detects the air pressure of a rear right tire of the vehicle, and an RL pressure sensor 24 detects the air pressure of a rear left tire of the vehicle.

A control device 1 receives the pressure signal from the input device 2 and outputs a control signal for alarming against theft and/or towing of the vehicle based on a comparison between the pressure corresponding to the received pressure signal and the predetermined pressure.

The control device 1 includes a receiving portion 11, a storing portion 17, a processing portion 12, a timer 16, a transmitting portion 15, a control portion 13, and a switch portion 14.

Detected signals from the pressure sensors mounted in the tires are transmitted to the receiving portion 11 of the control device 1 through the respective transmitting portions 26, 27, 28, and 29.

In this case, a wireless communication method is preferably realized as a communication method between the transmitting portions 26, 27, 28, and 29 and the receiving portion 11, but the communication method is not restricted to the wireless communication method. In addition, the wireless communication method is variably applied by request of a person of ordinary skill in the art.

The receiving portion 11 of the control device 1 converts the inputted signals into processable data (e.g., it converts an analog signal generated by the sensor into a digital signal), and transmits the data to the processing portion 12.

The storing portion 17 stores the predetermined pressure value, the scope of the predetermined allowable error, and the predetermined period.

The processing portion 12 compares present pressures of the tires with the predetermined pressure of tires stored in a storing portion 17, and the scope of the allowable error by the predetermined pressure. Subsequently, the processing portion 17 determines that the vehicle is stolen or towed in the case that at least one of the differences between the detected pressures of the tires and the predetermined pressure is within the scope of the allowable error of the predetermined pressure, and outputs a warning message if a state that at least one of the differences between the detected pressures of the tires and the predetermined pressure is within the scope of the allowable error of the predetermined pressure and is maintained for the predetermined period.

The processing portion 12 transmits a determination to a control portion 13, and the control portion 13 transmits a control signal to the transmitting portion 15 or the switch portion 14 by a predetermined process.

In addition, the transmitting portion 15 transmits the alarm message through a predetermined communication network 100 to the mobile terminal 4 that the owner or the manager of the vehicle carries, and the switch portion 14 operates an alarm device 3 mounted in the vehicle.

The predetermined communication network 100 connects the mobile terminal 4 to the transmitting portion 15, and it can be a conventional wireless communication network.

According to an embodiment of the present invention, a determined process therefrom is for a method for coping with vehicle theft or towing, and the process can be determined or changed by a person of ordinary skill in the art. The switch portion 14 can be realized as a switch circuit including a transistor, but it is not limited thereto.

In addition, in order to precisely distinguish a temporary pressure drop of the tires from a pressure drop of the tires by vehicle theft or towing, the processing portion 12 operates the timer 16 in case that at least one of the differences between the detected pressure of the tires and the predetermined pressure is within the scope of the allowable error of the predetermined pressure, and transmits a determination result (i.e., a warning message) to the control portion 13 if a state that at least one of the differences between the detected pressure of the tires and the predetermined pressure is within the scope of the allowable error of the predetermined pressure and is maintained for the predetermined period.

The present invention may be changed variably in a scope of the basic theory of the present invention by the request of a person of ordinary skill in the art.

As described, according to an embodiment of the present invention, because an internal pressure of the tires of the vehicle is detected in real time by the TPMS (Tire Pressure Monitoring System) mounted in a vehicle, a process and cost for mounting another system or other accessories are not needed.

In addition, according to an embodiment of the present invention that utilizes a TPMS, the system detects the internal air pressure of the tires, determines the vehicle theft and/or towing by the change (i.e., drop) of the detected air pressure of the tires, and operates the alarm device by informing the wireless terminal of the owner or manager of the vehicle. Therefore, with prevention of the vehicle theft by an operation of the alarm system, the present invention deals with a vehicle theft and/or towing by an owner or manager of a vehicle positively and improves confidence in the vehicle.

The control portion 13 can be realized by one or more processors activated by a predetermined program, and the predetermined program can be programmed to perform each step of a method according to an embodiment of this invention.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A method for alarming against theft and/or towing of a vehicle, comprising;
detecting internal pressures of tires mounted on the vehicle;
comparing the detected pressures with a predetermined pressure value;
operating a timer if at least one of differences between the detected pressures and the predetermined pressure value is within a scope of a predetermined allowable error; and
generating an alarm message in the case that a state that at least one of the differences between the detected pressures and the predetermined pressure value is within the scope of the predetermined allowable error and is maintained for a predetermined period.

2. The method of claim 1, wherein the predetermined pressure value is a pressure of the tires when a load of the vehicle does not act on the tires.

3. The method of claim 1, wherein detecting the internal pressures of the tires is performed by a TPMS (Tire Pressure Monitoring System).

4. A system for alarming against theft and/or towing of a vehicle, comprising;
an input device for detecting pressures of tires and for outputting a pressure signal corresponding to the detected pressures;
a control device for receiving the pressure signal from the input device and for outputting a control signal for alarming against theft and/or towing of the vehicle based on a comparison between the pressure value according to the received pressure signal and the predetermined pressure value;
an alarm device operated by the control signal from the control device; and
a terminal for receiving an alarm message according to the control signal of the control device.

5. The system of claim 4, wherein the predetermined pressure value is a pressure of the tires when a load of the vehicle does not act on the tires; and wherein the control device outputs the control signal for alarming against theft and/or towing of the vehicle in the case that a state that at least one of the differences between the detected pressures and the predetermined pressure value is in a scope of a predetermined allowable error and is maintained for a predetermined period.

6. The system of claim 4, wherein the input device is a TPMS (Tire Pressure Monitoring System).

7. The system of claim 5, wherein the control device comprises:
a receiving portion receiving the pressure signal from the input device and converting the pressure signal into processable data;
a storing portion for storing the predetermined pressure value, the scope of the predetermined allowable error, and the predetermined period;
a processing portion for comparing the pressure signal with the data stored in the storing portion and for transmitting a result thereof;
a control portion for transmitting a control signal according to the result transmitted from the processing portion;
a switch portion for operating the alarm device by the control signal transmitted from the control portion; and
a transmitting portion for transmitting an alarm message to a terminal according to the control signal transmitted from the control portion.

8. The system of claim 7, wherein the control device further comprises the timer operated by the result made by the processing portion.

9. A system for alarming against theft and/or towing of a vehicle comprising;
an input device for detecting pressures of tires and for outputting a pressure signal corresponding to the detected pressures;
a control device for receiving the pressure signal from the input device and for outputting a control signal for alarming against theft and/or towing of the vehicle based on a comparison between pressure values of the pressure signal and a predetermined pressure value; and
an alarm device operated by the control signal from the control device.

10. The system of claim 9, wherein the control device is configured to transmit a signal for alarming against theft and/or towing of the vehicle to a mobile communication terminal.

11. The system of claim 9, wherein the predetermined pressure value is a pressure of the tires when a load of the vehicle does not act on the tires; and
wherein the control device outputs the control signal for alarming against theft and/or towing of the vehicle in the case that a state that at least one of the differences between the detected pressures and the predetermined pressure value is in a scope of a predetermined allowable error and is maintained for a predetermined period.
